(19) United States
(12) Patent Application Publication
(10) Pub. No.: US 2024/0379999 A1
(43) Pub. Date: Nov. 14, 2024

(54) SOLID ELECTROLYTE MATERIAL FOR FLUORIDE ION BATTERY AND METHOD FOR PRODUCING SAME

(71) Applicant: NICHIA CORPORATION, Anan-shi (JP)

(72) Inventor: Shoma HATA, Tokushima-shi (JP)

(73) Assignee: NICHIA CORPORATION, Anan-shi (JP)

(21) Appl. No.: 18/659,152

(22) Filed: May 9, 2024

(30) Foreign Application Priority Data
May 10, 2023 (JP) 2023-077989

(51) Int. Cl. H01M 10/0562; C01F 17/36

(52) U.S. Cl. CPC H01M 10/0562; C01F 17/36; C01P 2006/40; C01P 2006/62; H01M 2300/008

(57) ABSTRACT

Provided is a solid electrolyte material for a fluoride ion battery. The solid electrolyte material includes: a metal composite fluoride containing: a lanthanoid metal; an alkali earth metal; and fluorine. The metal composite fluoride has, in an infrared absorption spectrum thereof, a ratio of a maximal value of absorption in a wave number range of 3,150 cm⁻¹ or greater and 3,250 cm⁻¹ or smaller to a maximal value of absorption in a wave number range of 400 cm⁻¹ or greater and 450 cm⁻¹ or smaller, that is 0.10 or smaller.

### CROSS-REFERENCE TO RELATED APPLICATIONS

This application claims priority to Japanese Patent Application No. 2023-077989, filed on May 10, 2023, the disclosure of which is hereby incorporated by reference in its entirety.

### BACKGROUND

### Field of the Invention

The present disclosure relates to a solid electrolyte material for a fluoride ion battery and a method for producing the same.

### Description of the Related Art

A fluoride ion solid battery utilizing a reaction of fluoride ions has been known as a battery achieving an energy density that is higher than that of a lithium ion battery. A fluoride ion battery operates at a high temperature of, for example, 150° C. or higher while a problem has been present that, in a low temperature state, the ion conductivity of a solid electrolyte therein is low and the fluoride ion battery does not therefore operate. Relating to this, for example, JP201877992A proposes a solid electrolyte material that has a tysonite structure.

### SUMMARY

A first aspect of the present disclosure is a solid electrolyte material for a fluoride ion battery, including a metal composite fluoride that includes a lanthanoid metal, an alkali earth metal, and fluorine. The metal composite fluoride has, in an infrared absorption spectrum thereof, the ratio of the maximal value of the absorption in a wave number range of 3,150 cm⁻¹ or greater and 3,250 cm⁻¹ or smaller to the maximal value of the absorption in a wave number range of 400 cm⁻¹ or greater and 450 cm⁻¹ or smaller, that is 0.10 or smaller.

A second aspect is a method for producing a solid electrolyte material for a fluoride ion battery, including providing a first metal composite fluoride that includes a lanthanoid metal, an alkali earth metal, and fluorine, and heat-treating the first metal composite fluoride in the presence of a fluorine-containing material to obtain a second metal composite fluoride.

According to an aspect of the present disclosure, a solid electrolyte material for a fluoride ion battery having high ion conductivity for fluoride ions may be provided.

### DETAILED DESCRIPTION

The term “step” as used herein encompasses not only an independent step but also a step not clearly distinguishable from another step as long as the intended purpose of the step is achieved. If multiple substances correspond to a component in a composition, the content of the component in the composition means the total amount of the multiple substances present in the composition unless otherwise specified. Further, upper limit and lower limit values that are described for a numerical range in the present specification can be arbitrarily selected and combined. Embodiments of the present invention will now be described in detail. The embodiments described below are exemplifications of a solid electrolyte material for a fluoride ion battery and a method for producing the same for embodying the technical ideas of the present invention, and the present invention is not limited to the solid electrolyte material for a fluoride ion battery and a method for producing the same described below.

### Solid Electrolyte Material for Fluoride Ion Battery

A solid electrolyte material for a fluoride ion battery (hereinafter, referred to also as “solid electrolyte material”) includes a metal composite fluoride that includes a lanthanoid metal, an alkali earth metal, and fluorine. The metal composite fluoride included in the solid electrolyte material has, in an infrared absorption spectrum thereof, a ratio of the maximal value of the absorption in a wave number range of 3,150 cm⁻¹ or greater and 3,250 cm⁻¹ or smaller to the maximal value of the absorption in a wave number range of 400 cm⁻¹ or greater and 450 cm⁻¹ or smaller (hereinafter, referred to also as “specific ratio”), that is 0.10 or smaller.

The solid electrolyte material including the metal composite fluoride that includes the lanthanoid metal, the alkali earth metal, and the fluorine can present high ion conductivity for fluoride ions by the fact that an absorption peak around 3,200 cm⁻¹ is small in an infrared absorption spectrum thereof. This may be considered, for example, as the following. The absorption peak around 3,200 cm⁻¹ may be regarded as the absorption peak originated from, for example, the stretching vibration of a hydroxyl group. It may be considered that the fact that the intensity of the absorption peak originated from the hydroxyl group is weak means that defects of the fluorine atoms are a few in the metal composite fluoride included in the solid electrolyte material, and it may be considered that the high ion conductivity may thereby be presented for the fluoride ions.

The metal composite fluoride including the lanthanoid metal, the alkali earth metal, and the fluorine has a strong absorption peak in a wave number range of 400 cm⁻¹ or greater and 450 cm⁻¹ or smaller in an infrared absorption spectrum thereof. As to the solid electrolyte material, the maximal value of the absorption in the wave number range of 3,150 cm⁻¹ or greater and 3,250 cm⁻¹ or smaller is evaluated using the maximal value of the absorption of the above strong absorption peak as a standard. The ratio of the maximal value of the absorption in the wave number range of 3,150 cm⁻¹ or greater and 3,250 cm⁻¹ or smaller to the maximal value of the absorption in the wave number range of 400 cm⁻¹ or greater and 450 cm⁻¹ or smaller (the specific ratio) of the solid electrolyte material may be 0.1 or smaller, 0.05 or smaller, 0.03 or smaller, or 0.02 or smaller. The specific ratio may be, for example, 0.001 or greater or 0.01 or greater. The infrared absorption spectrum of the solid electrolyte material is measured using a Fourier transformation infrared spectrometer and using an attenuated total reflection measurement method (an ATR method).

The solid electrolyte material whose specific ratios is in a specific range presents a high whiteness level. The whiteness level can be evaluated using, for example, the value of L* (illuminance) in an L*a*b* color space. The value of L* of the solid electrolyte material may be, for example, 70 or greater, and may be 80 or greater, 85 or greater, or 90 or greater. The value of L* in the L*a*b* color space is measured using a spectral colorimeter for a pellet formed by applying powder compression molding to the solid electrolyte material at 380 MPa.

The solid electrolyte material may include carbon atoms originated from the production method thereof. An organic solvent used in the production method, the carbon dioxide in the atmospheric air, and/or the like may each be regarded as the origin of the carbon atoms. In the case where the solid electrolyte material includes carbon atoms, the content of carbon (hereinafter, referred to also as “TC”) may be, for example, 200 ppm or smaller, and may be 150 ppm or smaller, 100 ppm or smaller, or 80 ppm or smaller. In the case where TC is smaller than the above ranges, the fluoride ion conductivity tends to further be improved due to the small amount of the impurity, The content of the carbon atoms (TC) may be, for example, 10 ppm or larger, 20 ppm or larger, or 30 ppm or larger. The content of the carbon atoms in the solid electrolyte material is measured by quantifying carbon dioxide that is generated by heat treatment, using, for example, a CHN elemental analyzer.

The solid electrolyte material presents high ion conductivity for the fluoride ions. The ion conductivity of the solid electrolyte material for the fluoride ions may be, for example, at 25° C., 10-7 (S/cm) or higher, and may be preferably 10-6 (S/cm) or higher, or 10-5 (S/cm). The ion conductivity of the solid electrolyte material is measured using a high frequency impedance measuring apparatus and using an AC impedance method.

The metal composite fluoride included in the solid electrolyte material may include a fluorite structure that includes a fluorine atom, a lanthanoid metal, and an alkali earth metal. The fluorite structure is generally an ionic crystal structure constituted by alkali earth metal ions and fluoride ions at ratios of 1:2. In the fluorite structure of the metal composite fluoride, lanthanoid metal ions are solid-solved in addition to the alkali earth metal ions and the fluoride ions. The ion conductivity is improved by the solid-solving of the lanthanoid metal ions in the fluorite structure. This can be considered as, for example, the following. The solid-solving of the lanthanoid metal ions increases the content ratio of the fluoride ions in the fluorite structure and the fluoride ions are thereby caused to be present each at an interstitial position. It may be considered that the above is because the fluoride ions become conductive among the lattices due to a conduction mechanism of a quasi-interstitial diffusion for the fluoride ions present at the interstitial positions and the fluoride ions present at the ordinary sites to be pushed out to be moved by chain-reaction crashes.

The metal composite fluoride included in the solid electrolyte material may include an additional component capable of forming additional ions each having an ion radius that is larger than that of the alkali earth metal ion, in addition to the lanthanoid metal and the alkali earth metal. In the case where the metal composite fluoride includes the additional component, the metal composite fluoride may have, as the main phase thereof, a crystal structure that includes the additional ions each having the ion radius that is larger than that of the alkali earth metal ions, in the fluorite structure including the fluoride ions, the lanthanoid metal ions, and the alkali earth metal ions (hereinafter, referred to also as “specific crystal structure”). High ion conductivity may thereby be achieved. It may be considered that this is because, for example, the fact that the additional ions each having the ion radius that is larger than that of the alkali earth metal ion are included in the crystal structure increases the lattice constant of the crystal of the metal composite fluoride, and the move in the crystal, of the fluoride ions responsible for the ion conduction is therefore facilitated.

In the case where the metal composite fluoride includes, as its main phase, the specific crystal structure, the content rate of the specific crystal structure in the crystal phase of the metal composite fluoride may be, for example, 60% by mole or higher. The content rate of the specific crystal structure in the crystal phase of the metal composite fluoride may be preferably 80% by mole or higher, or 100% by mole.

The fact that the metal composite fluoride includes, in its composition, the lanthanoid metal, the alkali earth metal, and the additional component may be confirmed including the content rates of the above by, for example, conducting an inductively coupled plasma (ICP) atomic emission spectroscopy analysis for the metal composite fluoride. Because the fluorite structure is generally an ionic crystal, it may be considered that detection of the lanthanoid metal, the alkali earth metal, and the additional component by the ICP atomic emission spectroscopy analysis indicates that these are present as ions in the crystal structure of the metal composite fluoride.

In the composition of the metal composite fluoride, the ratio of the number of moles of the fluorine atom to the total number of moles of the lanthanoid metal, the alkali earth metal, and the additional component (hereinafter, referred to also as “total number of moles of cations”) may be greater than 1.87 and smaller than 3. The ratio of the number of moles of the fluorine atom to the total number of moles of the cations in the composition of the metal composite fluoride may be preferably 1.9 or greater, or 2 or greater, and may be more preferably greater than 2. This ratio may be preferably 2.8 or smaller, or 2.6 or smaller, and may be more preferably 2.3 or smaller. When the ratio of the number of moles of the fluorine atom is in the above ranges, the ion conductivity tends to be further improved. The number of moles of the fluorine atom included in the composition of the metal composite fluoride is calculated assuming that the total number of moles of the lanthanoid metal ion, the alkali earth metal ion and the additional ion is 1 based on the metal ion amounts quantified by the ICP atomic emission spectroscopy analysis method, and taking into consideration the valence of each of these.

For example, it is assumed that La³⁺ that is the lanthanoid metal ion, Ba²⁺ that is the alkali earth metal ion, and Cs⁺ that is the additional ion are detected by the ICP atomic emission spectroscopy analysis method at the ratios of the numbers of moles of 1:1:1. In this case, assuming that the total number of moles of the lanthanum ions, the barium ions, and the cesium ions is 1, the detected amounts of the lanthanum ions, the barium ions, and the cesium ions are each 1/3 on a mole basis. Assuming that the valence of the lanthanum ion is 3, the valence of the barium ion is 2, and the valence of the cesium ion is 1, the number of moles of the fluoride ions included in the composition of the metal composite fluoride is calculated as

(1/3)×3+(1/3)×2+(1/3)×1=2.

Examples of the lanthanoid metal included in the metal composite fluoride included in the solid electrolyte material include lanthanum (La), cerium (Ce), praseodymium (Pr), neodymium (Nd), samarium (Sm), and the like. The lanthanoid metal includes preferably at least lanthanum, may further include cerium, samarium, and the like, and may include more preferably at least lanthanum. The ratio of the number of moles of lanthanum to the total number of moles of the lanthanoid metal included in the metal composite fluoride may be, for example, 0.5 or greater, and may be preferably 0.7 or greater, or 0.9 or greater. The ratio of the number of moles of lanthanum may be, for example, 1 or smaller.

The ratio of the number of moles of the lanthanoid metal in the composition of the metal composite fluoride, to the total number of moles of the lanthanoid metal, the alkali earth metal, and the additional component, may be, for example, greater than 0 and smaller than 0.8. The ratio of the number of moles of the lanthanoid metal may be preferably 0.05 or greater, or 0.1 or greater, and may be preferably 0.6 or smaller, or 0.4 or smaller. When the ratio of the number of moles of the lanthanoid metal is in the above ranges, the main phase of the metal composite fluoride may take the fluorite structure.

Examples of the alkali earth metal included in the metal composite fluoride included in the solid electrolyte material include calcium (Ca), strontium (Sr), barium (Ba), and the like. The alkali earth metal includes preferably at least barium, may further include strontium, calcium, and the like, and may include more preferably at least barium. The ratio of the number of moles of barium to the total number of moles of the alkali earth metal included in the metal composite fluoride may be, for example, 0.5 or greater, and may be preferably 0.7 or greater, or 0.9 or greater. The ratio of the number of moles of barium may be, for example, 1 or smaller.

The ratio of the number of moles of the alkali earth metal in the composition of the metal composite fluoride, to the total number of moles of the lanthanoid metal, the alkali earth metal, and the additional component, may be, for example, 0.2 or greater and smaller than 1. The ratio of the number of moles of the alkali earth metal may be preferably 0.4 or greater and may be 0.8 or smaller. When the ratio of the number of moles of the alkali earth metal is in the above ranges, the main phase of the metal composite fluoride can take the fluorite structure.

The ratio of the number of moles of the lanthanoid metal to the number of moles of the alkali earth metal in the composition of the metal composite fluoride may be, for example, greater than 0 and 4 or smaller. The ratio of the number of moles of the lanthanoid metal to the number of moles of the alkali earth atom may be preferably 0.1 or greater, or 0.3 or greater, and may be preferably 1.5 or smaller, or 1.0 or smaller.

The additional ions formed from the additional component included in the metal composite fluoride may be solid-solved in the crystal structure included in the metal composite fluoride as its main phase and may be substantially uniformly distributed in the overall crystal structure included in the metal composite fluoride as its main phase. The expression “the additional ions are solid-solved in the crystal structure included in the metal composite fluoride as its main phase” means that some of the cations constituting the crystal structure included in the metal composite fluoride as its main phase are replaced with the additional ions.

The additional component included in the metal composite fluoride only has to be a component capable of forming cations each having an ion radius that is larger than that of each of the alkali earth metal ions constituting the fluorite structure included in the metal composite fluoride. The cations formed from the additional component may be inorganic ions such as metal ions or may be organic cations. As to the ion radius of a cation, the value known through literatures may be employed for a metal ion. The ion radius of an organic cation is determined by a simulation calculation such as a density functional theory (DFT). For example, the ion radius of a tetramethylammonium determined using this method is about 0.18 nm to about 0.27 nm. Examples of the additional ion can include, for example, an inorganic ion such as a cesium (Cs) ion, rubidium (Rb), or an ammonium ion, and an organic cation such as a methylammonium ion, a dimethylammonium ion, a trimethylammonium ion, a tetramethylammonium ion, an ethylammonium ion, a diethylammonium ion, a triethylammonium ion, or a tetraethylammonium ion. The additional ion may include at least one type selected from the group consisting of a cesium (Cs) ion, a methylammonium ion, a dimethylammonium ion, a trimethylammonium ion, a tetramethylammonium ion, an ethylammonium ion, a diethylammonium ion, a triethylammonium ion, and a tetraethylammonium ion, and may include preferably at least a cesium ion.

The ratio of the number of moles of cesium to the total number of moles of the additional component included in the metal composite fluoride may be, for example, 0.5 or greater, and may be preferably 0.6 or greater, 0.8 or greater, or 0.98 or greater. The ratio of the number of moles of cesium may be, for example, 1 or smaller.

The additional ion has an ion radius that is larger than that of an alkali earth metal ion. The ratio of the ion radius of the additional ion to the ion radius of the alkali earth metal ion may be, for example, greater than 1 and 3 or smaller. The ratio of the ion radius of the additional ion to that of the alkali earth metal ion may be preferably 1.05 or greater, or 1.1 or greater, and may be preferably 2 or smaller.

The ratio of the number of moles of the additional component in the composition of the metal composite fluoride, to the total number of moles of the lanthanoid metal, the alkali earth metal, and the additional component, may be, for example, greater than 0 and smaller than 0.38. The ratio of the number of moles of the additional component may be preferably 0.05 or greater, or 0.2 or greater, and may be preferably 0.35 or smaller, or 0.3 or smaller.

The ratio of the number of moles of the additional component in the composition of the metal composite fluoride, to the number of moles of the alkali earth metal, may be, for example, greater than 0 and smaller than 1. The ratio of the number of moles of the additional component to the number of moles of the alkali earth metal may be preferably 0.1 or greater, or 0.4 or greater, and may be preferably 0.9 or smaller, or 0.7 or smaller. The ratio of the number of moles of the additional component in the composition of the metal composite fluoride, to the number of moles of the lanthanoid metal, may be, for example, greater than 0 and 1.5 or smaller. The ratio of the number of moles of the additional component to the number of moles of the lanthanoid metal may be preferably 0.1 or greater, or 0.3 or greater and may be preferably 1.2 or smaller, or 1.0 or smaller.

The metal composite fluoride may have a composition represented by Formula (1) as below.

Ln_{(1-x-y)}MₓA_{y}F_{z} (1)

In Formula (1), Ln represents the lanthanoid metal, M represents the alkali earth metal, and A represents the additional component. x, y, and z may satisfy 0<x<1, 0<y<1, 0<x+y<1, and 1.87<z<3. x and y may satisfy preferably 0.4≤x<1, 0.4<x+y<1, and 0<y<0.38. z may satisfy preferably 2≤z≤2.6. x and y may satisfy more preferably 0.4≤x<0.8, 0.4<x+y<1, and 0.05<y≤0.35. z may satisfy preferably 2<z≤2.3.

The metal composite fluoride may have a composition represented by Formula (1a) as below.

Ln_{(1-x-y)}MₓCs_{y}F_{z} (1a)

In Formula (1a), Ln represents the lanthanoid metal, and M represents the alkali earth metal. x, y, and z may satisfy 0<x<1, 0<y<1, 0<x+y<1, and 1.87<z<3. x and y may satisfy preferably 0.4≤x<1, 0.4<x+y<1, and 0<y<0.38. z may satisfy preferably 2≤z≤2.6. x and y may satisfy more preferably 0.4≤x<0.8, 0.4<x+y<1, and 0.05<y≤0.35. z may satisfy preferably 2<z≤2.3.

The details of each of a lanthanoid metal component, an alkali earth metal component, and the additional component in Formulae (1) and (1a) are as above.

In an X-ray diffraction (XRD) measurement measured using a CuKα line (λ=1.54 Å), the solid electrolyte material may have peaks at positions such as 2θ=25.3°±1°, 29.3°±1°, 41.9°±1°, and 49.6°±1°. The solid electrolyte material may have preferably at least two of these peaks concurrently, may have more preferably at least three of these peaks concurrently, and may have further preferably at least four of these peaks concurrently. The solid electrolyte material may be regarded as including the fluorite structure based on the fact that the solid electrolyte material has the peaks at the above positions.

The volume average particle diameter of the solid electrolyte material may be, for example, 1 nm or larger and 100 μm or smaller, and may be preferably 20 nm or larger and 10 μm or smaller. The volume average particle diameter of the solid electrolyte material can be obtained as the particle diameter that corresponds to 50% of the cumulative volume from the small diameter side in the cumulative particle size distribution on a volume basis. The cumulative particle size distribution on a volume basis is measured using, for example, a laser diffraction particle size distribution measuring apparatus.

### Method for Producing Solid Electrolyte Material for Fluoride Ion Battery

A method for producing the solid electrolyte material for a fluoride ion battery includes a first step of providing a first metal composite fluoride that includes the lanthanoid metal, the alkali earth metal, and the fluorine, and a second step of heat-treating the first metal composite fluoride in the presence of a fluorine containing material to obtain a second metal composite fluoride. The solid electrolyte material may include the second metal composite fluoride obtained at the second step, and may be a material consisting of the second metal composite fluoride.

The heat treatment of the first metal composite fluoride in the presence of the fluorine containing material reduces, for example, the defects of the fluorine atoms included in the first metal composite fluoride. In the case where a fluoride ion battery is manufactured, high ion conductivity of the fluoride ions may thereby be achieved therein.

### First Step

At the first step, the first metal composite fluoride including the lanthanoid metal, the alkali earth metal, and the fluorine is provided. The first metal composite fluoride may be provided by inheritance or the like, or may be provided by preparing a first metal composite fluoride having a desired configuration. The composition of the first metal composite fluoride to be provided may be same as that of the metal composite fluoride included in the above solid electrolyte material.

The first metal composite fluoride may be prepared using, for example, a first production method as follows. The first production method for the first metal composite fluoride may include a providing step of providing a mixture that includes a lanthanoid metal source and an alkali earth metal source and that, as necessary, includes the additional component, and a heat treatment step of obtaining the first metal composite fluoride by heat-treating the mixture at a predetermined temperature. The obtained first metal composite fluoride may have, as the main phase thereof, a crystal structure that includes the additional ions in the fluorite structure including the lanthanoid metal ions and the alkali earth metal ions. The additional ions may each have an ion radius that is larger than that of the alkali earth metal ion, and may include at least cesium ions. At least one type of the lanthanoid metal source, the alkali earth metal source, and the additional component may include the fluoride ions.

At the providing step, the mixture is provided that includes the lanthanoid metal source and the alkali earth metal source and that, as necessary, includes the additional component. The details of each of the lanthanoid metal included in the lanthanoid metal source, the alkali earth metal included in the alkali earth metal source, and the additional component are as above.

In one aspect, the lanthanoid metal source may include a lanthanoid metal fluoride, the alkali earth metal source may include an alkali earth metal fluoride, and the additional component may include a fluoride of the additional ion. Assuming that the content of the lanthanoid metal ions included in the lanthanoid metal fluoride is p mol, the content of the alkali earth metal ions included in the alkali earth metal fluoride is q mol, the content of the additional ions included in the fluoride of the additional ions is r mol, and the valence of the additional ion is n, the content ratios of the lanthanoid metal fluoride, the alkali earth metal fluoride and the fluoride of the additional ion in the mixture may be content ratios that satisfy 1.87< (3p+2q+nr)/(p+q+r)<3. The inclusion of the lanthanoid metal fluoride, the alkali earth metal fluoride, and the fluoride of the additional ion in the mixture at the above content ratios sets the ratio of the number of moles of the fluoride ions in the composition of the obtained first metal composite fluoride, to the total number of moles of the lanthanoid metal ions, the alkali earth metal ions, and the additional ions, to be greater than 1.87 and smaller than 3. The above (3p+2q+nr)/(p+q+r) may be preferably 1.9 or greater, or 2 or greater, and may be more preferably may be greater than 2. The above (3p+2q+nr)/(p+q+r) may be preferably 2.8 or smaller, or 2.6 or smaller, and may be more preferably 2.3 or smaller.

In one aspect, in the case where it is assumed that the total of the number of moles of the lanthanoid metals included in the lanthanoid metal source, the number of moles of the alkali earth metals included in the alkali earth metal source, and the number of moles of the additional component capable of forming the additional ions is 1, the mixture may have a composition in which the ratio of the number of moles of the fluoride ions included in the mixture is greater than 1.87 and smaller than 3. The ratio of the number of moles of the fluoride ions in the mixture may be preferably 1.9 or greater, or 2 or greater, and may more preferably exceed 2. The ratio of the number of moles of the fluoride ions therein may be preferably 2.8 or smaller, or 2.6 or smaller, and may be more preferably 2.3 or smaller.

Examples of the lanthanoid metal source included in the mixture may include a lanthanoid metal fluoride, a lanthanoid metal chloride, a lanthanoid metal hydroxide, a lanthanoid metal oxide, and the like. The lanthanoid metal source may be a hydrate. The lanthanoid metal source may include preferably at least a lanthanoid metal fluoride. The ratio of the number of moles of the lanthanoid metal fluoride to the total number of moles of the lanthanoid metal source, relative to the number of moles of the lanthanoid metal, may be, for example, 0.2 or greater, and may be preferably 0.8 or greater. The ratio of the number of moles of the lanthanoid metal fluoride may be, for example, 1 or smaller.

The purity of the lanthanoid metal source may be, for example, 50% or higher and may be preferably 80% or higher. The purity of the lanthanoid metal source may be, for example, 100% or lower.

Examples of the alkali earth metal source included in the mixture may include an alkali earth metal fluoride, an alkali earth metal chloride, an alkali earth metal hydroxide, an alkali earth metal oxide, and the like. The alkali earth metal source may be a hydrate. The alkali earth metal source may include preferably at least an alkali earth metal fluoride. The ratio of the number of moles of the alkali earth metal fluoride to the total number of moles of the alkali earth metal source, relative to the number of moles of the alkali earth metal, may be, for example, 0.2 or greater, and may be preferably 0.8 or greater. The ratio of the number of moles of the alkali earth metal fluoride may be, for example, 1 or smaller.

The purity of the alkali earth metal source may be, for example, 50% or higher, and may be preferably 80% or higher. The purity of the alkali earth metal source may be, for example, 100% or lower.

Examples of the additional component included in the mixture can include a fluoride of the additional ion, a chloride of the additional ion, a hydroxide of the additional ion, an oxide of the additional ion, and the like. The additional component may be a hydrate. The additional component may include preferably at least a fluoride of the additional ion. The ratio of the number of moles of the fluoride of the additional ion to the total number of moles of the additional component, relative to the number of moles of the additional ions, may be, for example, 0.2 or greater, and may be preferably 0.8 or greater. The ratio of the number of moles of the fluoride of the additional ion may be, for example, 1 or smaller. The additional component may include cesium atoms and the additional ions may be cesium ions.

The purity of the additional component may be, for example, 50% or higher and may be preferably 80% or higher. The purity of the additional component may be, for example, 100% or lower.

As to the mixing ratios of the lanthanoid metal source, the alkali earth metal source, and the additional component in the mixture, the ratio of the number moles of the lanthanoid metals included in the lanthanoid metal source to the total number of moles of the lanthanoid metals included in the lanthanoid metal source, the alkali earth metals included in the alkali earth metal source, and the additional ions included in the additional component (the total number of moles of the cations) may be, for example, greater than 0 and smaller than 0.8. The ratio of the number of moles of the lanthanoid metals to the total number of moles of the cations may be preferably 0.05 or greater, or 0.1 or greater, and may be preferably 0.6 or smaller, or 0.4 or smaller. The ratio of the number of moles of the alkali earth metals to the total number of moles of the cations may be, for example, 0.2 or greater and smaller than 1. The ratio of the number of moles of the alkali earth meatal atoms to the total number of moles of the cations may be preferably 0.4 or greater, and may be preferably 0.8 or smaller. The ratio of the number of moles of the additional ions to the total number of moles of the cations may be, for example, greater than 0 and smaller than 0.38. The ratio of the number of moles of the additional ions to the total number of moles of the cations may be preferably 0.05 or greater, or 0.2 or greater, and may be preferably 0.35 or smaller, or 0.3 or smaller.

The molar ratio of the content of the lanthanoid metals to that of the alkali earth metals in the mixture may be, for example, greater than 0 and 4 or smaller, or greater than 0 and 1.5 or smaller. The molar ratio of the content of the lanthanoid metals to that of the alkali earth metals therein may be preferably 0.1 or greater, or 0.3 or greater, and may be preferably 1.4 or smaller, 1.2 or smaller, or 1.0 or smaller.

The mixture may be prepared by weighing the lanthanoid metal source and the alkali earth metal source, and the additional component that is included as necessary to establish a desired blending ratios and thereafter mixing these with each other using a mixing method that uses a boll mill or the like, a mixing method that uses a mixing machine such as a Henschel mixer or a V-type blender, or the like. The mixing may be conducted as dry mixing, or wet mixing with a solvent added thereto. The mixture may be the one after undergoing a drying process. The drying process may be conducted by, for example, thermal drying, reduced pressure drying, freeze-drying, or the like, or may be conducted by a combination of these. The conditions for the thermal drying may be, for example, a temperature of 30° C. or higher and 200° C. or lower and a time period of 0.5 hours or longer and 24 hours or shorter.

The mixture may be preferably a mechanical ring processed material of the lanthanoid metal source and the alkali earth metal source, and the additional component that is included as necessary. The mixture may be a material that is obtained by mixing the lanthanoid metal source and the alkali earth metal source, and the additional component that is included as necessary, with each other using a mechanical milling process. The mechanical milling process may be conducted using, for example, a planetary ball mill, a bead mill, a ball mill, or a jet mill. In the case where a planetary ball miss is used, the condition for the mechanical milling process may be a time period of 0.5 hours or longer and 48 hours or shorter and may be preferably 5 hours or longer and 24 hours or shorter.

At the heat treatment step, heat treatment is applied to the provided mixture at a predetermined first heat treatment temperature to obtain the first metal composite fluoride. The first heat treatment temperature at the heat treatment step is, for example, 200° C. or higher and 1,000° C. or lower, may be preferably 300° C. or higher, or 400° C. or higher, and may be preferably 700° C. or lower, or 600° C. or lower.

The heat treatment may include a step of increasing the temperature to the predetermined first heat treatment temperature, a step of maintaining the first heat treatment temperature, and a step of decreasing the temperature from the first heat treatment temperature. The rate of increasing the temperature to the first heat treatment temperature as the rate of increasing the temperature from, for example, the room temperature may be 1° C./minute or higher and 20° C./minute or lower, may be preferably 5° C./minute or higher, and may be preferably 10° C./minute or lower. The time period of the heat treatment to maintain the first heat treatment temperature may be, for example, 1 hour or longer, and may be preferably 5 hours or longer. The time period for the heat treatment may be, for example, 48 hours or shorter and may be preferably 20 hours or shorter, or 10 hours or shorter. The rate of decreasing the temperature from the first heat treatment temperature as the rate of decreasing the temperature to, for example, the room temperature may be 1° C./minute or higher and 20° C./minute or lower.

The atmosphere used at the heat treatment step may be, for example, an inert gas atmosphere. Examples of the inert gas may include a nitrogen gas and a noble gas such as argon. As to the inert gas atmosphere, the content rate of the inert gas may be, for example, 90% by volume or higher, and may be preferably 95% by volume or 98% by volume or higher, and the inert gas may be at substantially 100% by volume. Here, substantially means that the presence of any gas other than the inert gas that is unavoidably mixed therein is not eliminated. The content rate of the gas other than the inert gas may be, for example, 1% by volume or lower.

The pressure of the atmosphere used at the heat treatment step may be, for example, 0 MPa or higher and 1 MPa or lower as a gauge pressure. The heat treatment for the mixture may be conducted using, for example, a tubular furnace or a furnace bottom lifting furnace.

The first metal composite fluoride obtained at the heat treatment step may have a composition in which the ratio of the number of moles of the lanthanoid metal to the total number of moles of the lanthanoid metal, the alkali earth metal, and the additional ion is greater than 0 and smaller than 0.6, in which the ratio of the number of moles of the alkali earth metal thereto is 0.4 or greater and smaller than 1.0, and in which the ratio of the number of moles of the additional ion thereto is greater than 0 and smaller than 0.38.

The first metal composite fluoride may be produced using a second production method as follows. The second production method for the first metal composite fluoride may include a precursor providing step of providing a precursor and a precursor heat treatment step of heat-treating the precursor to obtain the first metal composite fluoride. The obtained first metal composite fluoride may have, as the main phase thereof, the crystal structure including the additional ions in the fluorite structure that includes the lanthanoid metal ions and the alkali earth metal ions. The additional ions may each have an ion radius that is larger than that of the alkali earth metal ion, and may include at least cesium ions.

At the precursor providing step, a precursor is provided that includes the lanthanoid metal, the alkali earth metal, and the fluorine, and that, as necessary, includes the additional ion. The details of each of the lanthanoid metal, the alkali earth metal, and the additional ion are as above.

The precursor including the lanthanoid metal, the alkali earth metal, and the fluorine may be prepared, for example, as follows. A first water solution including the lanthanoid metal ions, a second water solution including the alkali earth metal ions, and a third water solution including the fluorine ions are mixed with each other and the precursor can thereby be prepared as a fluoride including the lanthanoid metal and the alkali earth metal. The precursor produced by mixing the first water solution, the second water solution, and the third water solution with each other can be collected by solid-liquid separation (such as, for example, filtering).

The mixing may be conducted by mixing, for example, a mixture of the first water solution and the second water solution, with the third water solution. Otherwise, the first water solution and the second water solution may be added to the third water solution to be mixed with each other. The temperature for the mixing may be, for example, 0° C. or higher and 100° C. or lower, and may be preferably 10° C. or higher and 80° C. or lower. The atmosphere for the mixing may be, for example, an atmosphere of the atmospheric air. The time period of the mixing may be, for example, 1 hour or longer and 72 hours or shorter, and may be preferably 10 hours or longer and 24 hours or shorter. The time period of the mixing in the above is the time period from the time point at which the mixing ratios of the water solutions become the ratios within a desired range to the start of the next process, such as, for example, the filtrating process.

The first water solution may be a water solution of the lanthanoid metal source. Examples of the lanthanoid metal source included in the first water solution may include an inorganic acid salt, an acetate, an oxalate, and the like of the lanthanoid metal. Types of the inorganic acid salt include a nitrate salt, a sulfate, a halogen acid salt, and the like. The purity of the lanthanoid metal source may be, for example, 50% or higher and may be preferably 80% or higher. The purity of the lanthanoid metal source may be, for example, 100% or lower. The concentration of the lanthanoid metal ions in the first water solution may be, for example, 1 mmol/kg or higher, and 1,000 mol/kg or lower, may be preferably 10 mmol/kg or higher, or 100 mmol/kg or higher, and may be preferably 100 mol/kg or lower, or 10 mol/kg or lower.

The second water solution may be a water solution of the alkali earth metal source. Examples of the alkali earth metal source included in the second water solution may include an inorganic acid salt, an acetate, and an oxalate, of the alkali earth metal. Types of the inorganic acid salt include a nitrate salt, a sulfate, a halogen acid salt, and the like. The purity of the alkali earth metal source may be, for example, 50% or higher and may be preferably 80% or higher. The purity of the alkali earth metal source may be, for example, 100% or lower. The concentration of the alkali earth metal ions in the water solution of the alkali earth metal source may be, for example, 1 mmol/kg or higher, and 1,000 mol/kg or lower, may be preferably 10 mmol/kg or higher, or 100 mmol/kg or higher, and may be preferably 100 mol/kg or lower, or 10 mol/kg or lower.

The third water solution may be a water solution of the fluoride ion source. Examples of the fluoride ion source included in the third water solution may include ammonium fluoride, hydrofluoric acid, methylammonium fluoride, and the like. The purity of the fluoride ion source may be, for example, 50% or higher and may be preferably 80% or higher. The purity of the fluoride ion source may be, for example, 100% or lower. The concentration of the fluoride ions in the water solution including the fluoride ions may be, for example, 1 mmol/kg or higher, and 1,000 mol/kg or lower, may be preferably 10 mmol/kg or higher, 100 mmol/kg or higher, or 1 mol/kg or higher, and may be preferably 100 mol/kg or lower, or 50 mol/kg or lower.

The mixing ratios of the first water solution and the second water solution at the precursor providing step, as the molar ratio of the lanthanoid metal ions included in the second water solution to the alkali earth metal ions included in the first water solution, may be, for example, greater than 0 and 4 or smaller, or may be greater than 0 and 1.5 or smaller. The molar ratio of the lanthanoid metal ions to the alkali earth metal ions may be preferably 0.1 or greater, 0.3 or greater, or 0.5 or greater, and may be preferably 1.4 or smaller, 1.2 or smaller, 1.0 or smaller, or 0.8 or smaller. The mixing ratio of the third water solution, as the molar ratio of the fluoride ions included the third water solution to the total number of moles of the lanthanoid metal ions and the alkali earth metal ions, may be, for example, 0.8 or greater and 5 or smaller, may be preferably 1.2 or greater, 1.5 or greater, or 3 or greater, and may be 4.5 or smaller, or 4 or smaller.

The precursor obtained by mixing the first water solution, the second water solution, and the third water solution may be included in a precipitate that is generated by the mixing of the first water solution, the second water solution, and the third water solution. The precipitate including the precursor may be collected from the reaction mother liquid by solid-liquid separation. A washing process may be conducted for the precipitate obtained by the solid-liquid separation. The washing process may be conducted using, for example, a liquid medium including water. The washing process may be conducted by holding the precipitate in a funnel and causing the liquid medium to pass therethrough, or may be conducted by solid-liquid separation for a mixture of the precipitate and the liquid medium. The washing process may be conducted until the electric conductivity of the liquid medium separated from the precipitate becomes, for example, 1 mS/cm or lower, preferably 0.5 mS/cm or lower, or 0.1 mS/cm or lower.

A drying process may be conducted for the precursor that includes the lanthanoid metal, the alkali earth metal, and the fluorine atom, that is obtained as above. The drying process may be conducted by, for example, heat treatment of the precursor. The temperature of the drying process may be, for example, 50° C. or higher and 300° C. or lower, and may be preferably 100° C. or higher, or 200° C. or lower. The drying process may be conducted at a reduced pressure. The atmospheric pressure employed in the case where the drying process is conducted at a reduced pressure may be, for example 10 Pa or lower and may be preferably 0.01 Pa or lower.

The precursor may further include the additional ion derived from the additional component, in addition to the lanthanoid metal, the alkali earth metal, and the fluorine atom. The additional ion may include at least cesium ions and may substantially be cesium ions. The precursor including the additional ion may be prepared by mixing a fluoride that includes the lanthanoid metal and the alkali earth metal, and the additional component that generates the additional ion, with each other. For example, the precursor including the additional ion may be obtained by mixing a solution or a dispersion liquid of the additional component that includes the additional component and a liquid medium, and the fluoride including the lanthanoid metal and the alkali earth metal, with each other. At least a portion of the liquid medium may be removed from the obtained precursor that includes the additional ion.

Examples of the additional component included in the solution or the dispersion liquid may include a fluoride of the additional ion, a chloride of the additional ion, a hydroxide of the additional ion, an oxide of the additional ion, a carbonate of the additional ion, a hydride of the additional ion, and the like. The details of the additional component are described above. The liquid medium included in the solution or the dispersion liquid of the additional component may include at least water and may substantially be water. The liquid medium may include a liquid other than water. In the case where the liquid medium includes a liquid other than water, examples of the liquid other than water may include an organic solvent such as an alcohol having one to eight carbon atom(s), methanol, or ethanol. The content of the additional component in the solution or the dispersion liquid of the additional component may be, for example, 50% by mass or larger and 99.99% by mass or smaller, and may be preferably 90% by mass or larger and 99% by mass or smaller.

The mixing ratio of the fluoride including the lanthanoid metal and the alkali earth metal, and the additional component, as the molar ratio of the additional ion included in the additional component to the fluoride including the lanthanoid metal and the alkali earth metal, may be, for example, 0.1 or greater and 0.5 or smaller and may be preferably 0.2 or greater, or 0.3 or smaller.

The mixing ratios of the fluoride including the lanthanoid metal and the alkali earth metal, and the additional component may be set as necessary corresponding to the aimed composition of the precursor that includes the additional ion. For example, in the case where the additional component is a fluoride of the additional ion, assuming that the content of the lanthanoid metal included in the fluoride is p mol, the content of the alkali earth metal ion is q mol, the content of the additional ion included in the fluoride of the additional ion is r mol, and the valence of the additional ion is n, the mixing ratios of the fluoride including the lanthanoid metal and the alkali earth metal, and the fluoride of the additional ion may be a mixing ratio that satisfies 1.87< (3p+2q+nr)/(p+q+r)<3. (3p+2q+nr)/(p+q+r) may be preferably 1.9 or greater, or 2 or greater and may more preferably exceed 2. (3p+2q+nr)/(p+q+r) may be preferably 2.8 or smaller, or 2.6 or smaller, and may be more preferably 2.3 or smaller.

As to the contents of the lanthanoid meta atom, the alkali earth metal, and the additional ion in the precursor that includes the additional ion, the ratio of the number moles of the lanthanoid metal to the total number of moles of the lanthanoid metal, the alkali earth metal, and the additional ion (the total number of moles of cations) may be, for example, greater than 0 and 0.8 or smaller. The ratio of the number of moles of the lanthanoid metal to the total number of moles of cations may be preferably 0.05 or greater, or 0.1 or greater, and may be preferably 0.6 or smaller, or 0.4 or smaller. The ratio of the number of moles of the alkali earth metal to the total number of moles of cations may be, for example, 0.2 or greater and smaller than 1. The ratio of the number of moles of the alkali earth metal to the total number of moles of cations may be preferably 0.4 or greater and may be preferably 0.8 or smaller. The ratio of the number of moles of the additional ion to the total number of moles of cations may be, for example, greater than 0 and smaller than 0.38. The ratio of the number of moles of the additional ion to the total number of moles of cations may be preferably 0.05 or greater, or 0.2 or greater, and may be preferably 0.35 or smaller, or 0.3 or smaller.

The first metal composite fluoride may be obtained by heat treatment of the precursor obtained as above. The temperature of the heat treatment for the precursor (hereinafter, referred to also as “second heat treatment temperature”) is, for example, 200° C. or higher and 1,000° C. or lower, may be preferably 300° C. or higher, 400° C. or higher, or 500° C. or higher, and may be preferably 800° C. or lower, or 700° C. or lower. The heat treatment for the precursor may include a step of increasing the temperature to a predetermined second heat treatment temperature, a step of maintaining the second heat treatment temperature, and a step of decreasing the temperature from the second heat treatment temperature. The rate of increasing the temperature to the second heat treatment temperature as the rate of increasing the temperature from, for example, the room temperature may be 1° C./minute or higher, and 20° C./minute or lower, may be preferably 5° C./minute or higher, and may be preferably 10° C./minute or lower. The time period of the heat treatment to maintain the second heat treatment temperature may be, for example, 1 hour or longer, and may be preferably 5 hours or longer. The time period of the heat treatment may be, for example, 48 hours or shorter and may be preferably 20 hours or shorter, or 15 hours or shorter. The rate of decreasing the temperature from the second heat treatment temperature as the rate of decreasing the temperature to, for example, the room temperature may be 1° C./minute or higher and 20° C./minute or lower.

The atmosphere used for the heat treatment for the precursor may be, for example, an inert gas atmosphere. Examples of the inert gas include a nitrogen gas and a noble gas such as argon. As to the inert gas atmosphere, the content rate of the inert gas may be, for example, 90% by volume or higher, and may be preferably 95% by volume, or 98% by volume or higher, and the inert gas may be at substantially 100% by volume. Here, substantially means that the presence of any gas other than the inert gas that is unavoidably mixed therein is not eliminated. The content rate of the gas other than the inert gas may be, for example, 1% by volume or lower.

The atmosphere for the heat treatment for the precursor may be an atmosphere that includes a fluorine containing material. In this case, effects such as reduction of the defects of the fluorine atoms in the crystal structure and reduction of impurities are expected. Examples of the fluorine containing material in the atmosphere for the neat treatment include, for example, F₂, CHF₃, CF₄, PF₃, PH₅, BF₃, NH₄HF₂, HF, SiF₄, AsF₃, KrF₄, XeF₂, XeF₄, NF₃, SF₄, C₂F₆, C₃F₈, SiF₄, SF₆, CFC, HCFC, HFC, C₂F₄, C₂F₆, C₃F₈, and NOF. In the case where the atmosphere for the heat treatment for the precursor includes the fluorine containing material, the concentration of the fluorine containing material in the atmosphere may be, for example, 3% by volume or higher and 35% by volume or lower, may be preferably 5% by volume or higher, or 10% by volume or higher, and may be preferably 30% by volume or lower, or 25% by volume or lower. In the case where the atmosphere for the heat treatment for the precursor includes the fluorine containing material, the production method for the solid electrolyte material for a fluoride ion battery may include a second step described later or may not include the second step.

The pressure of the atmosphere for the heat treatment for the precursor may be, for example, 0 MPa or higher and 1 MPa or lower as a gauge pressure. The heat treatment for the precursor may be conducted using, for example, a tubular furnace or a furnace bottom lifting furnace.

The first metal composite fluoride obtained by the heat treatment of the precursor may have a composition in which the ratio of the number of moles of the lanthanoid metal to the total number of moles of the lanthanoid metal, the alkali earth metal, and the additional ion is greater than 0 and smaller than 0.6, in which the ratio of the number of moles of the alkali earth metal thereto is 0.4 or greater and smaller than 1.0, and in which the ratio of the number of moles of the additional ion thereto is greater than 0 and smaller than 0.38.

### Second Step

At the second step, heat-treating the first metal composite fluoride in the presence of a fluorine containing material to obtain the second metal composite fluoride. At the second step, the second metal composite fluoride may be obtained by the heat-treatment of the first metal composite fluoride that is contacted with the fluorine containing material. The obtained second metal composite fluoride may be the desired solid electrolyte material.

It may be considered that fluorine atoms are supplied to the region defecting fluorine atoms in the crystal structure of the first metal composite fluoride by the heat treatment of the first metal composite fluoride that is contacted with the fluorine containing material and the second metal composite fluoride whose defects of the crystal structure are further reduced is therefore obtained. It may be considered that high ion conductivity of the fluoride ions may thereby be achieved in the solid electrolyte material. It may also be considered that the durability of the solid electrolyte material is improved.

The fluorine containing material used at the second step may be in any of a solid state, a liquid state, and a gas state at the ambient temperature. Examples of the fluorine containing material in the solid state or the liquid state include, for example, NH₄F. Examples of the fluorine containing material in the gas state include, for example, F₂, CHF₃, CF₄, PF₃, PH₅, BF₃, NH₄HF₂, HF, SiF₄, AsF₃, KrF₄, XeF₂, XeF₄, NF₃, SF₄, C₂F₆, C₃F₈, SiF₄, SF₆, CFC, HCFC, HFC, C₂F₄, C₂F₆, C₃F₈, and NOF. The fluorine containing material may include at least one type selected from the group consisting of F₂, CHF₃, CF₄, NH₄HF₂, HF, SiF₄, KrF₂, XeF₂, XeF₄, and NF₃, and may include preferably at least one type selected from the group consisting of F₂ and HF.

In the case where the fluorine containing material is the one in the solid state or the liquid state at the ambient temperature, the first metal composite fluoride and the fluorine containing material may be brought into contact with each other by mixing these with each other. The first metal composite fluoride may be mixed with, for example, 1% by mass or larger and 20% by mass or smaller, and preferably 2% by mass or larger and 10% by mass or smaller of the fluorine containing material, converted into the mass of the fluorine atoms, relative to the total amount, 100% by mass, of the first metal composite fluoride and the fluorine containing material.

The temperature for mixing the first metal composite fluoride and the fluorine containing material with each other may be a temperature of, for example, 20° C. or higher and lower than 400° C.° and may be a temperature of more preferably 150° C. or higher. In the case where the temperature for bringing the first meal composite fluoride and the fluorine containing material that is in the solid state or the liquid state at the ordinary temperature is 30° C. or higher and lower than 200° C., the heat treatment at the second step may be conducted at a temperature of 200° C. or higher after bringing the first metal composite fluoride and the fluorine containing material into contact with each other.

In the case where the fluorine containing material is a gas, the first metal composite fluoride may be placed in an atmosphere that includes the fluorine containing material, to be brought into contact therewith. The atmosphere including the fluorine containing material may include an inert gas such as a noble gas or nitrogen in addition to the fluorine containing material. In this case, the concentration of the fluorine containing material in the atmosphere may be, for example, 3% by volume or higher and 35% by volume or lower, may be preferably 5% by volume or higher, or 10% by volume or higher, and may be preferably 30% by volume or lower, or 25% by volume or lower.

The heat treatment at the second step may be conducted by maintaining a third heat treatment temperature for a predetermined time period in the state where the first metal composite fluoride and the fluorine containing material are brought into contact with each other. The third heat treatment temperature may be, for example, 100° C. or higher, and 650° C. or lower, and may be preferably 400° C. or higher, 425° C. or higher, 450° C. or higher, or 480° C. or higher. The third heat treatment temperature may be preferably lower than 600° C., 580° C. or lower, 550° C. or lower, or 520° C. or lower.

When the third heat treatment temperature is equal to or higher than the above lower limit values, fluorine atoms are sufficiently supplied to the first metal composite fluoride and the ion conductivity of the fluoride ions tends to be further improved in the obtained solid electrolyte material. When the third heat treatment temperature is equal to or lower than the above upper limit values, decomposition of the obtained first metal composite fluoride is further effectively suppressed and the ion conductivity of the fluoride ions tends to be further improved in the obtained solid electrolyte material.

The time period of the heat treatment at the second step, that is, the time period to maintain the third heat treatment temperature may be, for example, 1 hour or longer and 40 hours or shorter, may be preferably 2 hours or longer, or 3 hours or longer, and may be preferably 30 hours or shorter, 10 hours or shorter, or 8 hours or shorter. When the time period of the heat treatment at the third heat treatment temperature is in the above ranges, fluorine atoms may sufficiently be supplied to the first metal composite fluoride after contacting with the liquid medium. The crystal structure of the second metal composite fluoride is thereby further stabilized and a solid electrolyte material whose ion conductivity of the fluoride ions is high tends to be obtained.

The pressure for the heat treatment at the second step may be the atmospheric pressure (0.101 MPa), may be higher than the atmospheric pressure and 5 MPa or lower, and may be higher than the atmospheric pressure and 1 MPa or lower.

The method for producing the solid electrolyte material may include a granulating step of conducting processes such as crushing, powdering, and a particle size classification operation in combination for the second metal composite fluoride obtained after the second step. Powder having a desired particle diameter may be obtained by the granulating step.

### EXAMPLES

The present invention will be described in detail below with reference to Examples while the present invention is not limited to Examples.

### Example 1

### Composite Fluoride Production Step

The composite fluoride was prepared as follows. Barium nitrate (Ba(NO₃)₂), lanthanum nitrate (La(NO₃)₃·6H₂O), and ammonium fluoride (NH₄F) were each separately added to 1 kg of pure water to each be stirred at the room temperature in an atmosphere of the atmospheric air to each be solved. A barium nitrate water solution at 0.2 mol./kg, a lanthanum nitrate water solution at 1 mol./kg, and an ammonium fluoride water solution at 10 mol/kg were thereby each prepared.

600 g of the barium nitrate water solution (at 0.2 mol./kg) and 80 g of the lanthanum nitrate water solution (at 1 mol./kg) were added to a reaction tank to be mixed with each other at the room temperature in an atmosphere of the atmospheric air. 72 g of the ammonium fluoride water solution (at 10 mol/kg) was thereafter added to the reaction tank to be stirred for 20 hours.

Washing with pure water was conducted for the filtering residue obtained by filtering the above reaction solution until the electric conductivity of the filtrate became 0.1 mS/cm or lower, to obtain a precipitate. Heat treatment was applied to the precipitate at 120° C. for 12 hours in a vacuum to obtain the precursor of the first metal composite fluoride. It was confirmed using an ICP analysis that the composition ratios of Ba:La of the obtained precursor were Ba:La=0.6:0.4.

A dispersion produced by dispersing 1.92 g of cesium fluoride (CsF) in 0.1 g of water was added to 9.28 g of the obtained precursor of the first metal composite fluoride to be mixed with each other to thereafter be dry-solidified by applying heat treatment to the mixture at 200° C. for 6 hours. Heat treatment was further applied to the dry-solidified material at 600° C. for 10 hours in an argon atmosphere to obtain the first metal composite fluoride. The composition of the first metal composite fluoride was Ba_{0.48}La_{0.32}Cs_{0.2}F_{2.12} as the charge ratios.

The obtained first metal composite fluoride was put in a tubular furnace and heat treatment was applied thereto at 500° C. for 8 hours in an atmosphere including a fluorine gas at 20% by volume and a nitrogen gas at 80% by volume to thereby obtain a solid electrolyte material according to Example 1 as the second metal composite fluoride.

### Comparative Example 1

The first metal composite fluoride obtained in Example 1 was taken as a solid electrolyte material according to Comparative Example 1.

### Composition Analysis

For each of the solid electrolyte materials obtained as above, the composition of the solid electrolyte material was determined using an inductively coupled plasma (ICP) atomic emission spectroscopy analysis. For example, the solid electrolyte materials were each alkali-solved and were thereafter each hydrochloric acid-heating-solved as a preprocessing method, to measure the composition amounts of the metal ions using an inductively coupled plasma (ICP) atomic emission spectroscopy apparatus (ICP-AES: Optima 8300: manufactured by Perkin Elmer, Inc.) to determine the molar ratio of the fluorine ion in the composition assuming that the total of the composition amounts of the metal ions is 1. Table 1 shows the result thereof.

### Ion Conductivity Measurement

For each of the solid electrolyte materials obtained as above, a solid electrolyte layer specimen was fabricated as below. 200 mg of the solid electrolyte material was weighed and was pressed at 380 MPa to obtain the solid electrolyte layer specimen.

For the solid electrolyte layer specimen obtained as above, measurement was conducted using a high frequency impedance measurement system (an impedance analyzer E4990A-type manufactured by Keysight Technologies) and using an AC impedance method (the measurement temperature: 25° C., the applied voltage: 500 mV, the measurement frequency region: 120 MHz to 20 Hz) to calculate the ion conductivity of the fluoride ion from the thickness of the solid electrolyte layer specimen and the resistance value on the real axis of a Cole-Cole plot. Table 1 shows the result thereof.

### Measurement of Illuminance

Each of the solid electrolyte materials obtained as above was pressurized at 380 MPa to produce a powder compression molded body having the diameter of 10 mm and the thickness of 22 mm, and the L* value (the illuminance) thereof was measured using a spectrophotometric colorimeter CM-700d manufactured by KONIKA MINOLTA Inc. Table 1 shows the result thereof.

### Infrared Absorption Spectrum

For each of the obtained solid electrolyte materials, an infrared absorption spectrum was measured using a Fourier transformation infrared spectrometer (the product name: Nicoleti S50 manufactured by Thermo Fisher Scientific) and using the ATR method to determine the ratio of the maximal value of the absorption in the wave number range of 3,150 cm⁻¹ or greater and 3,250 cm⁻¹ or smaller to the maximal value of the absorption in the wave number range of 400 cm⁻¹ or greater and 450 cm⁻¹ or smaller (the specific ratio). Table 1 shows the result thereof. The infrared absorption spectrum using ATR-IR was measured at the wave number resolution of 4.0 cm⁻¹ and for the number of the integration sessions of 32.

1 g of each of the solid electrolyte materials was weighed, heat treatment was applied thereto at 900° C. in an atmosphere of the atmospheric air, and carbon dioxide generated from the heat-treated material was quantified using a CHN element analyzing apparatus to thereby determine the mass rate of carbon included in the specimen as the total carbon amount (TC: ppm).

TABLE 1

| | | Ion | | | |
|---|---|---|---|---|---|
| | | conductivity | | TC | Specific |
| | Composition | (S/cm) | L* | (ppm) | ratio |
| Example 1 | La_{0.35}Ba_{0.49}Cs_{0.16}F_{2.19} | 9.6 × 10⁻⁴ | 93.08 | 70 | 0.0186 |
| Comparative | La_{0.34}Ba_{0.49}Cs_{0.17}F_{2.19} | 5.1 × 10⁻⁸ | 67.62 | 270 | 0.1410 |
| Example 1 | | | | | |

As shown in Table 1, the solid electrolyte material according to Example 1 presents high ion conductivity.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

Although the present disclosure has been described with reference to several exemplary embodiments, it is to be understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular examples, means, and embodiments, the disclosure may be not intended to be limited to the particulars disclosed; rather the disclosure extends to all functionally equivalent structures, methods, and uses such as are within the scope of the appended claims.

One or more examples or embodiments of the disclosure may be referred to herein, individually and/or collectively, by the term “disclosure” merely for convenience and without intending to voluntarily limit the scope of this application to any particular disclosure or inventive concept. Moreover, although specific examples and embodiments have been illustrated and described herein, it should be appreciated that any subsequent arrangement designed to achieve the same or similar purpose may be substituted for the specific examples or embodiments shown. This disclosure may be intended to cover any and all subsequent adaptations or variations of various examples and embodiments. Combinations of the above examples and embodiments, and other examples and embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure may be not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter shall be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure may be determined by the broadest permissible interpretation of the following claims and their equivalents, and shall not be restricted or limited by the foregoing detailed description.

All publications, patent applications, and technical standards mentioned in this specification are herein incorporated by reference to the same extent as if each individual publication, patent application, or technical standard was specifically and individually indicated to be incorporated by reference.

What is claimed is:

1. A solid electrolyte material for a fluoride ion battery, the solid electrolyte material comprising:
a metal composite fluoride comprising:
a lanthanoid metal;
an alkali earth metal; and
fluorine,
wherein the metal composite fluoride has, in an infrared absorption spectrum thereof, a ratio of a maximal value of absorption in a wave number range of 3,150 cm⁻¹ or greater and 3,250 cm⁻¹ or smaller to a maximal value of absorption in a wave number range of 400 cm⁻¹ or greater and 450 cm⁻¹ or smaller, that is 0.10 or smaller.

2. The solid electrolyte material according to claim 1, wherein
the metal composite fluoride further comprises cesium.

3. The solid electrolyte material according to claim 1, wherein
the metal composite fluoride has a value of L* that is 70 or greater in an L*a*b* color space.

4. The solid electrolyte material according to claim 1, wherein
the metal composite fluoride has a total content of carbon that is 200 ppm or smaller.

5. The solid electrolyte material according to claim 2, wherein
the metal composite fluoride has a value of L* that is 70 or greater in an L*a*b* color space.

6. The solid electrolyte material according to claim 2, wherein
the metal composite fluoride has a total content of carbon that is 200 ppm or smaller.

7. The solid electrolyte material according to claim 2, wherein
the metal composite fluoride has a composition in which, to a total number of moles of the lanthanoid metal, the alkali earth metal, and the cesium,
a ratio of a number of moles of the lanthanoid metal is greater than 0 and smaller than 0.6,
a ratio of a number of moles of the alkali earth metal is 0.4 or greater and smaller than 1.0, and
a ratio of a number of moles cesium is greater than 0 and smaller than 0.38.

8. The solid electrolyte material according to claim 1, wherein
the metal composite fluoride has a composition represented by the Formula (1a),
Ln_{(1-x-y)}MₓCs_{y}F_{z} (1a), wherein
Ln represents the lanthanoid metal,
M represents the alkali earth metal, and
0<x<1, 0≤y<1, 0<x+y<1, and 1.87<z<3.

9. The solid electrolyte material according to claim 8, wherein
0.4≤x<1, 0.4<x+y<1, and 0<y<0.38.

10. A method for producing a solid electrolyte material for a fluoride ion battery, the method comprising:
providing a first metal composite fluoride comprising a lanthanoid metal, an alkali earth metal, and fluorine; and
heat-treating the first metal composite fluoride in presence of a fluorine-containing material to obtain a second metal composite fluoride.

11. The method according to claim 10, wherein
the first metal composite fluoride has a composition in which a ratio of a number of moles of the lanthanoid metal to a number of moles of the alkali earth metal is greater than 0 and 1.5 or smaller.

12. The method according to claim 10, wherein
the first metal composite fluoride further comprises cesium.

13. The method according to claim 12, wherein
the first metal composite fluoride has a composition in which, to a total number of moles of the lanthanoid metal, the alkali earth metal, and cesium,
a ratio of a number of moles of the lanthanoid metal is greater than 0 and smaller than 0.6,
a ratio of a number of moles of the alkali earth metal is 0.4 or greater and smaller than 1.0, and
a ratio of a number of moles of cesium is greater than 0 and smaller than 0.38.

14. The method according to claim 12, wherein
the heat-treating to obtain the second metal composite fluoride is conducted at a temperature in a range of 100° C. or higher and 650° C. or lower.

15. The method according to claim 12, wherein
the fluorine-containing material comprises at least one selected from the group consisting of F₂, CHF₃, CF₄, NH₄HF₂, HF, SiF₄, KrF₂, XeF₂, XeF₄, and NF₃.

16. The method according to claim 10, wherein
the heat-treating to obtain the second metal composite fluoride is conducted at a temperature in a range of 100° C. or higher and 650° C. or lower.

17. The method according to claim 10, wherein
the fluorine-containing material comprises at least one selected from the group consisting of F₂, CHF₃, CF₄, NH₄HF₂, HF, SiF₄, KrF₂, XeF₂, XeF₄, and NF₃.
